(19) United States
(12) Patent Application Publication
(10) Pub. No.: US 2005/0215245 A1
(43) Pub. Date: Sep. 29, 2005

(54) Method and system for the use of different wireless technologies within a hybrid switch protocol stack

(76) Inventors: Lu Tian, Plano, TX (US); Jianming Xu, Plano, TX (US)

Correspondence Address: Alcatel;Intellectual Property Department, 3400 W Plano Parkway, M S Legl2, Plano, TX, 75075, US

(21) Appl. No.: 10/521,125

(22) PCT Filed: Jul. 12, 2003
(86) PCT No.: PCT/US03/22086

§ 371 Date: Jan. 12, 2005

Related U.S. Application Data
(60) Provisional application No. 60/395,256, filed on Jul. 12, 2002.

(51) Int. Cl. H04Q 7/20

(52) U.S. Cl. 455/422.1; 455/450

(57) ABSTRACT

Provided is a method and system for enabling communication between mobile devices (102, 202), radio access networks (RANs; 104, 204), and core networks (CNs; 302) based on different specifications and underlying technologies. For example, a mobile station (MS; 102, 202) may be compatible with multiple standards or specifications (e.g., GSM and CDMA), and may need to communicate with a network via an interface that is not compatible with the network (e.g., a GSM network and a CDMA interface). A hybrid MSC (304) that is compatible with both standards may be provided between the GSM network and the CDMA interface. In some examples, the hybrid MSC (304) may inherit components or functionality from both the network and the interface, which enables the hybrid MSC (304) to handle messages from both without needing to change either of them. For example, the hybrid MSC (304) may receive messages from the network and encapsulate them in one or more messages compatible with the interface for transmission over the interface.

### CROSS-REFERENCE

This application claims priority from U.S. Provisional Patent Application 60/395,256, filed on Jul. 12, 2002.

### BACKGROUND

The present disclosure relates generally to voice and data communications and, more particularly, to a wireless system and method for providing services to a wireless mobile terminal operating in a hybrid wireless network.

A wireless network may be composed of two sub-networks. The first subnetwork may be a Radio Access Network (RAN) which handles radio related issues, such as assigning radio resources to establish and maintain a communication session with a mobile communications device upon a request for service. The second sub-network may be a Core Network (CN) which links a user of a mobile device to a wireline network. The wireless network, its sub-networks, and mobile devices within the network may communicate using a standardized set of signals and commands known as a specification.

Available specifications for the wireless network may specify that the RAN and the CN of the wireless network are based on the same wireless technology. Such networks may be referred to as “homogenous networks.” For instance, if the RAN and the CN are based on a technology such as Global System for Mobile communications (GSM), a mobile subscriber using a GSM compliant device may utilize the network Likewise, if the RAN and the CN are based on a technology such as code division multiple access 2000 (CDMA2000), a mobile subscriber using a CDMA2000 compliant device may utilize the network.

However, due in part to incompatibilities between different specifications, such as GSM and CDMA2000, a mobile device may only be able to utilize networks based on a particular specification. This is a primary disadvantage of homogenous networks because, given the many wireless technologies that currently exist and that are being developed, access may be unavailable when a mobile device compatible with one wireless technology moves into a wireless network of different technology. This prevents the mobile device from accessing services and limits the mobile device's geographical service area to networks that support a specific wireless technology. For example, a mobile device compliant only with GSM cannot generally access a network based solely on CDMA2000. As the number of differing existing and proposed specifications grows, this limitation may become increasingly problematic.

Therefore, what is needed is a method and system that can provide wireless service to a mobile device regardless of the underlying network technology. It is desirable to enable a mobile device to exchange message contents with a wireless network without concern for possible differences in the technologies involved (e.g., message encoding and decoding schemes). It is also desirable to provide such wireless service without inconveniencing the user.

### SUMMARY

In one embodiment, a method is provided for transferring information from a network via an interface incompatible with the network to a mobile device that is compatible with both the network and the interface. The method comprises establishing a communication channel between the mobile device and a switch, wherein the switch is accessible to the network and is adapted to send and receive messages compatible with both the network and interface. Information is received from the network and the information is inserted into a first message compatible with the interface. The first message is transferred to the mobile device via the interface.

### BRIEF DESCRIPTION OF THE DRAWINGS

FIG. 1 illustrates a GSM wireless network architecture for providing services to a mobile device.

FIG. 2 illustrates a CDMA wireless network architecture for providing services to a mobile device.

FIG. 3 illustrates a hybrid wireless network architecture with a hybrid mobile switching center (hybrid MSC), a RAN using GSM wireless technology, a RAN using CDMA wireless technology, and a CN using GSM wireless technology.

FIG. 4 illustrates an example of a protocol architecture that may be used in the hybrid MSC of FIG. 3.

FIG. 5 is an exemplary flow chart of a method for servicing a mobile device using the protocol architecture of FIG. 4.

FIG. 6 is an exemplary flow chart of one possible implementation of the method of FIG. 5 in the hybrid wireless network of FIG. 3.

FIG. 7 illustrates a call flow diagram for performing a mobile originated voice call when the mobile device is operating in a CDMA RAN that is serviced by the hybrid MSC of FIG. 3 in a GSM Core network.

FIG. 8 illustrates a call flow diagram for performing a mobile terminated voice call when the mobile device is operating in a CDMA RAN that is serviced by the hybrid MSC of FIG. 3 in a GSM Core network

### DETAILED DESCRIPTION

The present disclosure relates generally to voice and data communications and, more particularly, to a wireless system and method for providing services to a wireless mobile terminal operating in a hybrid wireless network. It is understood, however, that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

For the purposes of clarity in the present disclosure, various acronyms are used, the definitions of which are listed below:

| | |
|---|---|
| ANSI-41 | American National Standards Institute - Cellular |
| | Radio |
| | Telecommunications Intersystem Operations; |
| AuC | Authentication center; |
| BSC | Base Station Controller; |
| BSS | Base Station Subsystem; |
| BTS | Base Transceiver Station; |
| GMSC | Gateway MSC; |
| GSM | Global System for Mobile communications; |
| HLR | Home Location Register; |
| IOS | Interoperability Specification |
| IP | Internet Protocol; |
| IS41 | Wireless Network conforming to the IS41 standard; |
| ISDN | Integrated Services Digital Network; |
| ISUP | ISDN User Part (of SS7); |
| MSC | Mobile Switching Center; |
| PSTN | Public Switch Telephone Network; |
| SCP | Signalling Control Point; |
| SMS-C | Short Message Service Center; |
| SS7 | Signaling System No. 7; |
| TI | Digital communication line that uses time division |
| | multiplexing; |
| TCP/IP | Transmission Control Protocol/Internet Protocol. |

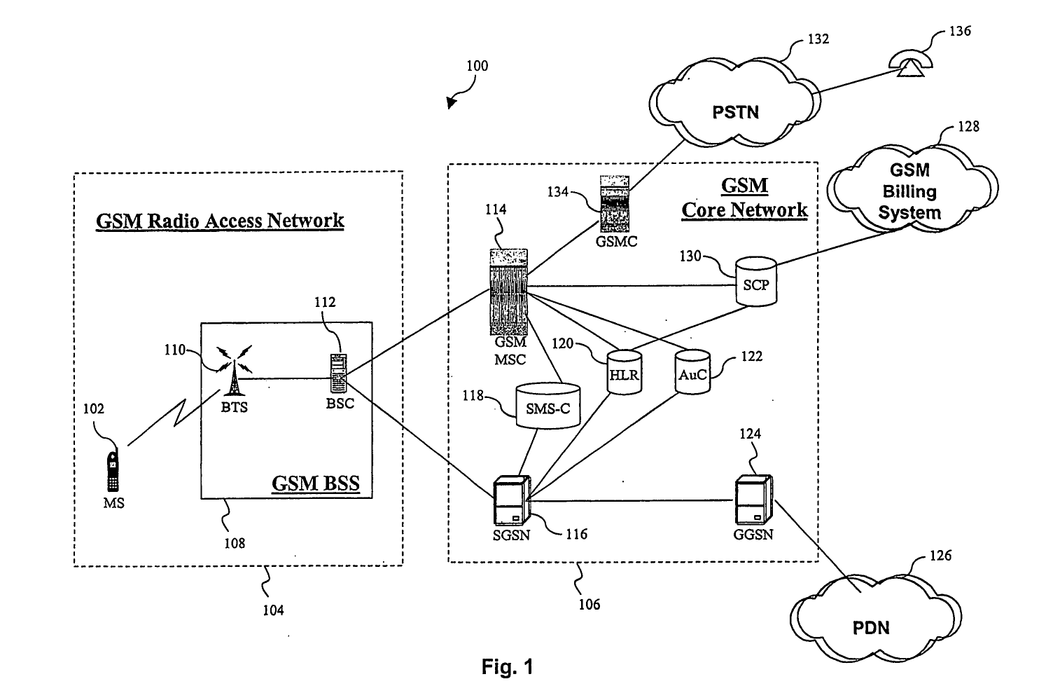

Referring to FIG. 1, an exemplary GSM network 100 is operable to provide wireless services to a GSM compliant mobile device 102 (also known as a “mobile station” (MS)). The network 100 includes a RAN 104 and a CN 106, both of which are based on GSM technology. The RAN 104 includes a BSS 108, which may include a BTS 110 and a BSC 112 to establish and maintain a communication session with the mobile device 102. In the present example, the BSC 112 may be in communication with a MSC 114 and a Serving General Packet Radio Service (GPRS) Support Node (collectively “SGSN”) 116. Both the MSC 114 and the SGSN 116 may be connected to a SMS-C 118, an HLR 120, and an AuC 122. The SGSN 116 may also be connected to a Gateway GPRS Support Node (GGSN) 124, which may in turn connect to a packet data network (PDN) 126. The MSC 114 and the HLR 120 may also be connected to a billing system 128 through a SCP 130. The MSC 114 may also be connected to another network, such as a PSTN 132, through a GMSC 134. This connection enables the mobile device 102 to communicate with another device that is not part of the network 100, such as a wireline telephone 136.

It is noted that a variety of protocols may be utilized to enable communications to occur through the various components 110-134. For example, some communications may use Signaling System 7 Integrated Services Digital Network (ISDN) User Part (known collectively as “SS7 ISUP”) or Internet Protocol (IP), while others may utilize GPRS Tunneling Protocol U (GTP-U) for user data and GTP-C for signaling.

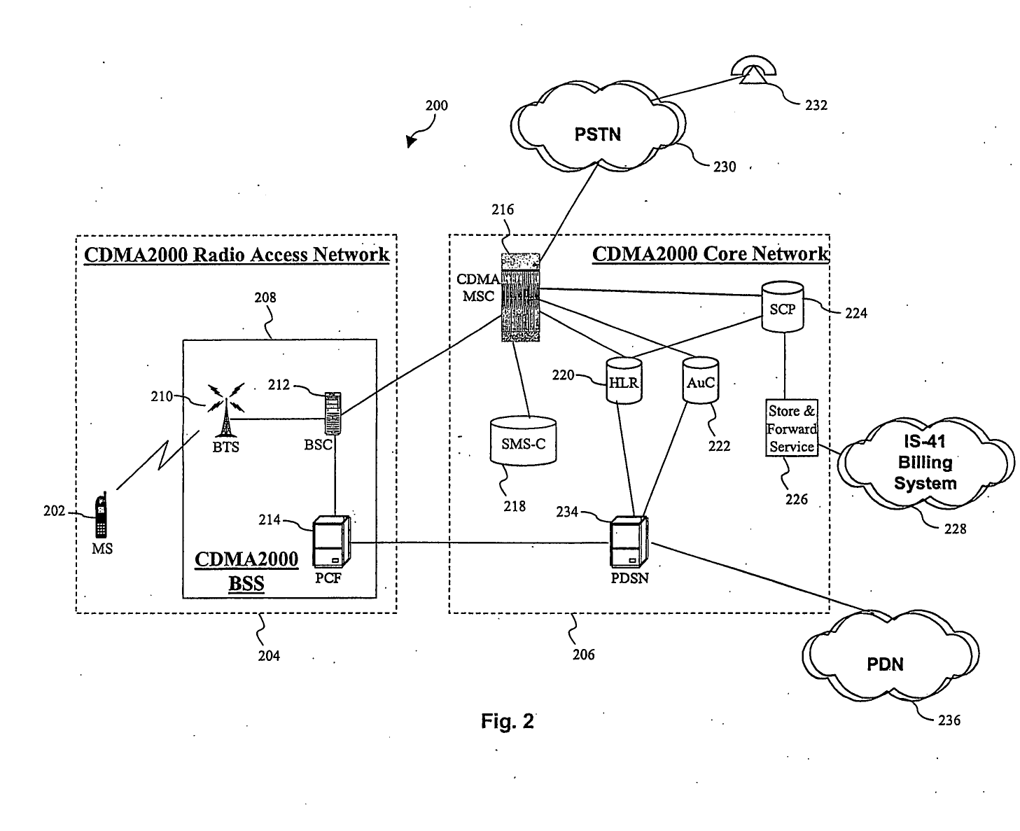

Referring now to FIG. 2, an exemplary CDMA2000 network 200 is operable to provide wireless services to a CDMA2000 compliant mobile device 202. The network 200 includes a RAN 204 and a CN 206, both of which are based on CDMA2000 technology. The RAN 204 includes a BSS 208, which may include a BTS 210, a BSC 212, and a packet control function (PCF) 214. In the present example, the BSC 112 may be in communication with a MSC 216 and the PCF 214. The MSC 216 may be connected to a SMS-C 218, a HLR 220, an AuC 222, and a SCP 224. The SCP 224 may be connected to a component 226 that is operable to store and forward a service to a billing system 228. Alternatively, the SCP 224 may store and forward the service itself. The MSC 216 may also be connected to another network, such as a PSTN 230. This connection enables the mobile device 202 to communicate with a device on another network, such as a wireline telephone 232 connected to the PSTN 230. The PCF 214 may be connected to a packet data serving node (PDSN) 234 as well as the BSC 212. The PDSN 234 may in turn be connected to the HLR 220, the SCP 222, and a PDN 236.

It is noted that a variety of protocols may be utilized to enable communications to occur through the various components 210-236. For example, some communications may use SS7 ISUP, while others may utilize IP.

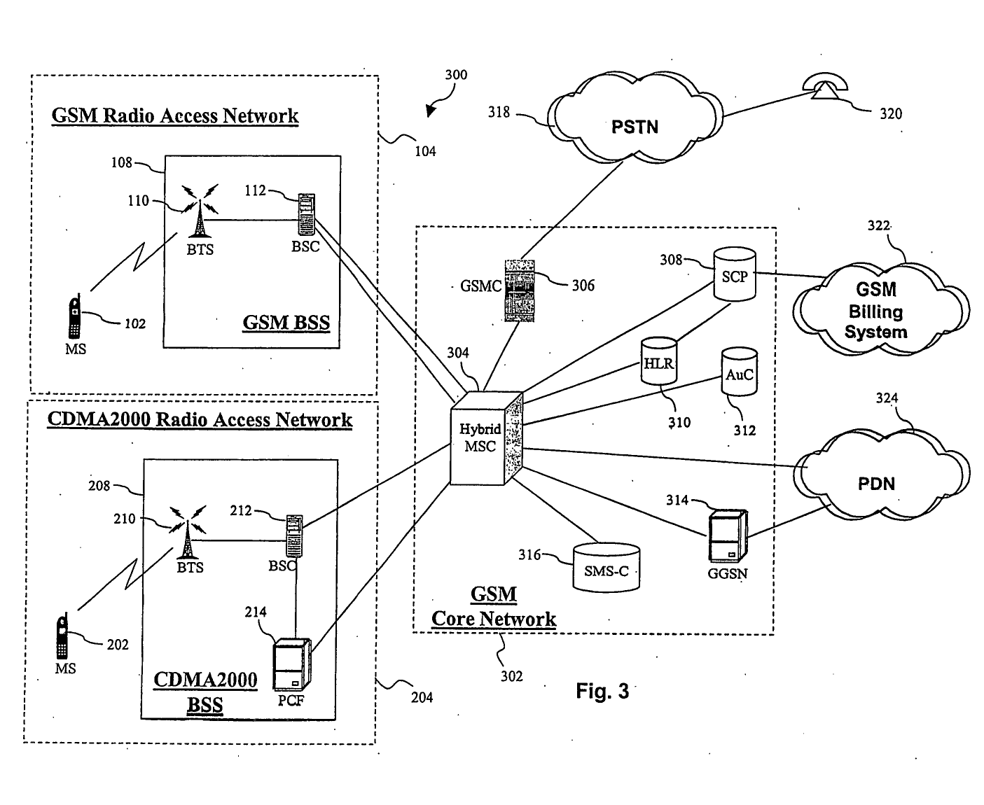

Referring now to FIG. 3, in one embodiment, a network 300 is operable to service both the GSM compliant mobile device 102 of FIG. 1 and the CDMA2000 compliant mobile device 202 of FIG. 2. Although the mobile devices 102, 202 may support both voice and packet data, the present disclosure applies to any type of mobile device that can operate in a given RAN. For example, one or both of the mobile devices 102, 202 may be a single mode mobile device that can support either voice or data, a dual mode mobile device that can support voice and data but at different times of service, or may be one of plurality of other combinations of mobile types and services. Furthermore, although illustrated as mobile telephones, the mobile devices 102, 202 may be any type of device able to connect to the network 300.

The network 300 is structured so as to connect RANs based on different technologies with a single CN. In the present example, the network 300 connects the GSM RAN 104 of FIG. 1 and the CDMA2000 RAN 204 of FIG. 2 with a GSM CN 302. A “hybrid” MSC 304 is utilized to connect the RANs 104, 204 with the CN 302, as is described in greater detail in PCT Application Number W02002US35500, filed on Nov. 5, 2002, and hereby incorporated by reference as if reproduced in its entirety. The hybrid MSC 304 may be implemented using software and/or hardware.

In the present example, the MSC 304 may be connected to a GMSC 306, SCP 308, a HLR 310, an AuC 312, a GGSN 314, and a SMS-C 316. The GMSC 306 may be connected to another network, such as a PSTN 318. This connection may be operable to enable one or both of the mobile devices 102, 202 to communicate with a device on another network, such as a wireline telephone 320 on the PSTN 318. The SCP 308 may be connected to a billing system 322. A PDN 324 may be connected to both the MSC 304 and the GGSN 314. The hybrid MSC 304 enables a mobile terminal in one of the RANs 104 or 204 and certain network entities in the CN 302 to exchange message contents without being obstructed by the differences in the technologies involved (e.g., message encoding and decoding schemes).

In operation, as will be described below in greater detail, the MSC 304 may handle the control and bearer traffic using a centralized call control model for both the GSM RAN 104 and the CDMA2000 RAN 204. Setting-up and controlling a voice or a data call for either of the mobile devices 102, 202 may be done at the MSC 304 as follows. For calls established using the GSM mobile device 102, the MSC 304 operates in a manner similar to the GSM MSC 114 of FIG. 1. For calls established using the CMDA2000 mobile device 202, the MSC 304 links the CDMA2000 RAN 204 to the GSM CN 302.

This linking may be accomplished by converting messages initiated in the CDMA2000 RAN 204 into GSM messages sent to the CN 302. Likewise, GSM messages initiated by the CN 302 may be converted into CDMA2000 messages sent to the RAN 204. Alternatively, the MSC 304 may create a new message that corresponds to a received message, as is described in greater detail in previously incorporated PCT Application Number WO2002US35500. The linking between the CDMA2000 RAN 204 and the GSM CN 302 may also be accomplished by initiating a function or procedure in one portion of the network 300 using one technology (e.g., CDMA or GSM) upon receiving a certain message from another portion of the network 300 using the other technology (e.g., GSM or CDMA). As will be described below in greater detail, the hybrid MSC 304 may also encapsulate information to facilitate the transfer of information via an otherwise incompatible network or device. Accordingly, the GSM CN 302 may communicate with both the GSM RAN 104 and the CDMA2000 RAN 204, which enables setup calls to be initiated at one of the RANs 104, 204 or at the CN 302.

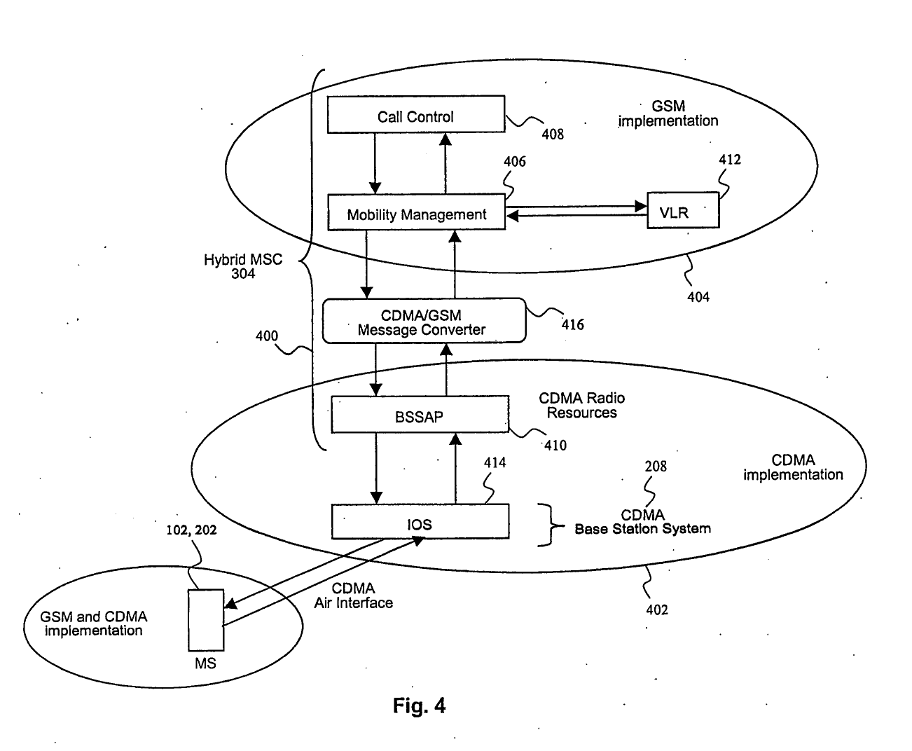

Referring now to FIG. 4, an exemplary protocol architecture 400 is illustrated, such as may be used in the hybrid MSC 304 of FIG. 3. As described previously, the hybrid MSC 304 may be deployed in a core network (e.g., the CN 302 of FIG. 3) to enable communication between incompatible technologies (e.g., GSM and CDMA) while minimizing changes to the technologies themselves. This provides the ability to pass information or message contents between a mobile device (e.g., the mobile device 202 of FIG. 3, which is both GSM and CDMA compatible in the present example) and various networks entities when the information or messages are not compliant with the radio interface technology. To accomplish this, the hybrid MSC 304 is implemented using a protocol architecture that enables multiple core networks (e.g., both GSM and CDMA) to co-exist in the same switch. This enables, for example, the passing of GSM information transparently to the CDMA RAN 204 (FIG. 3) between the mobile device 202 and GSM entities in the CN 302. In the context of messaging, the message contents may be encoded, packaged, and decoded appropriately.

FIG. 4 illustrates the protocol architecture 400 of the hybrid MSC 304. The architecture 400 inherits certain aspects from both a CDMA implementation 402 and a GSM implementation 404. For example, the architecture 400 inherits a mobility management (MN) agent 406 and a call control (CC) agent 408 from GSM, and a Base Station System Application Part (BSSAP) and Radio Resource manager 410 from the CDMA protocol. No changes are introduced to these elements. The MM 404, CC 408, and BSSAP 410 may correspond to different processes that may be implemented in a switch and may have the same functionality when used in a “pure” CDMA MSC or a “pure” GSM MSC. Note that the term “pure” means that the MSC communicates using the same wireless technology on the Radio and the Core networks.

The MM agent 406 may access mobile user information from a local database such as a visitor location register (VLR) 412. The BSSAP 410 communicates with mobile devices via an interoperability specification (IOS) 414 compliant CDMA BSS (e.g., the BSS 208 of FIG. 3). A message converter module 416 is placed between the GSM entities and the CDMA entities of the hybrid MSC's protocol stack. This module is responsible for converting messages from GSM to CDMA and vice versa, as will be described later in greater detail.

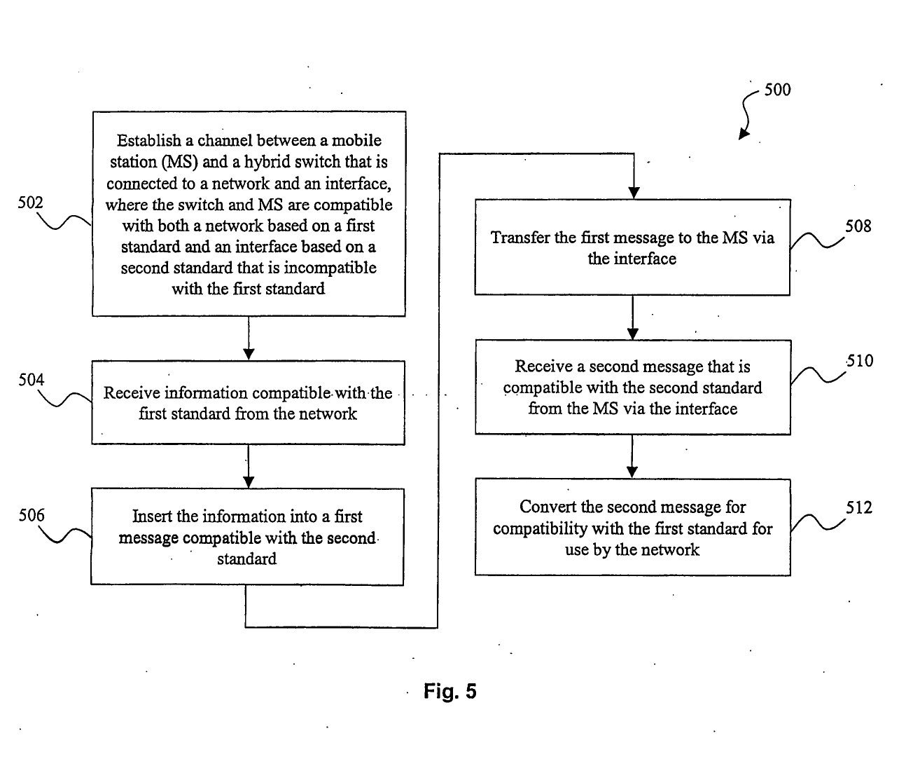

Referring now to FIG. 5, in one embodiment, a method 500 enables a mobile station (MS) and a network to communicate via an air interface using a hybrid switch. In the present example, the switch and MS are compatible with both the network, which is based on a first standard, and the interface, which is based on a second standard that is incompatible with the first standard. The switch is connected to both the network and the interface.

In step 502, a channel is established between the switch and the MS. This may occur before the MS is authenticated with the network or may occur after such authentication occurs. In step 504, the switch receives information compatible with the first standard from the network This information is inserted by the switch into a first message compatible with the second standard in step 506, and the first message is transferred to the MS via the interface in step 508. The mobile device may then extract the information from the first message. In step 510, the switch receives a second message compatible with the second standard from the MS via the interface. In step 512, the switch converts the second message for compatibility with the first standard for use by the network

In some embodiments, the MS may insert information compatible with the first standard into the second message. The switch would then, upon receipt of the second message, extract the information and relay it to the network. Alternatively, all information in the second message may be compatible with the second standard. The switch would then convert the information from the second standard into corresponding information compatible with the first standard and relay it to the network

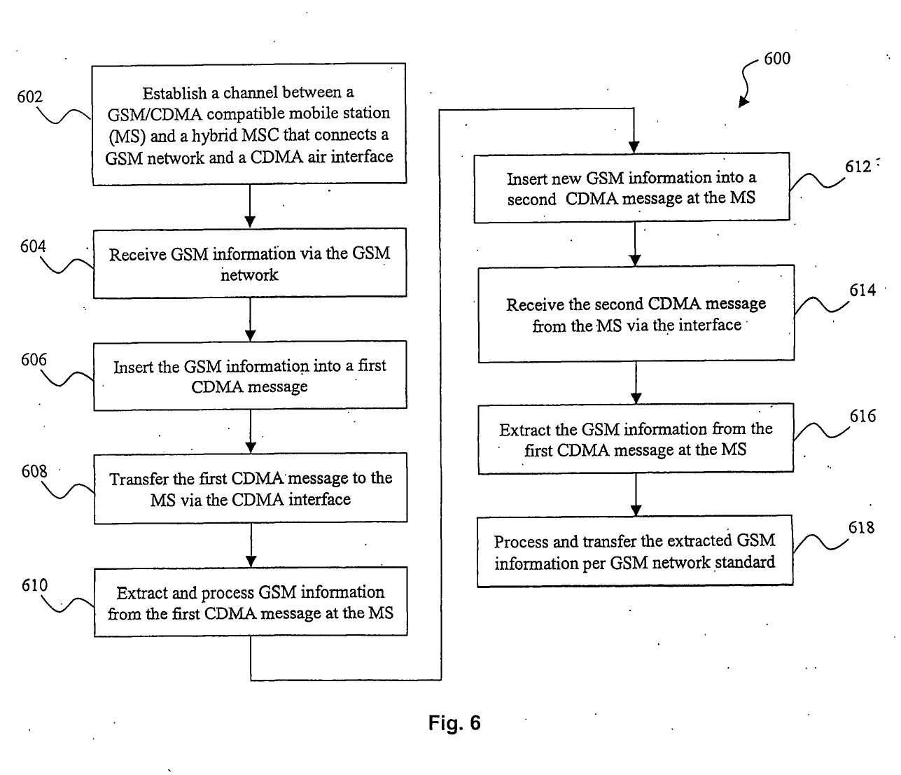

Referring now to FIG. 6, in another embodiment, a method 600 illustrates one possible implementation of the method 500 of FIG. 5 within the hybrid network 300 of FIG. 3. In step 602, a channel is established between the hybrid MSC 304 and a GSM/CDMA compatible mobile station (MS) 202. The hybrid MSC 304 receives GSM information via the GSM CN 302 in step 604 and inserts the GSM information into a first CDMA message in step 606. In the present example, the CDMA message may be an “ADDS Deliver” message that has a variable length field. The GSM information is inserted into the variable length field.

In step 608, the hybrid MSC 304 transfers the first CDMA message to the MS 202 via the CDMA interface. The MS 202 extracts and processes the GSM information from the first CDMA message in step 610 and, in step 612, inserts its own GSM information into a second CDMA message. The hybrid MSC 304 receives the second CDMA message from the MS 202 in step 614 and extracts the GSM information in step 616. The extracted GSM information may then processed and transferred per the GSM network standard in step 618.

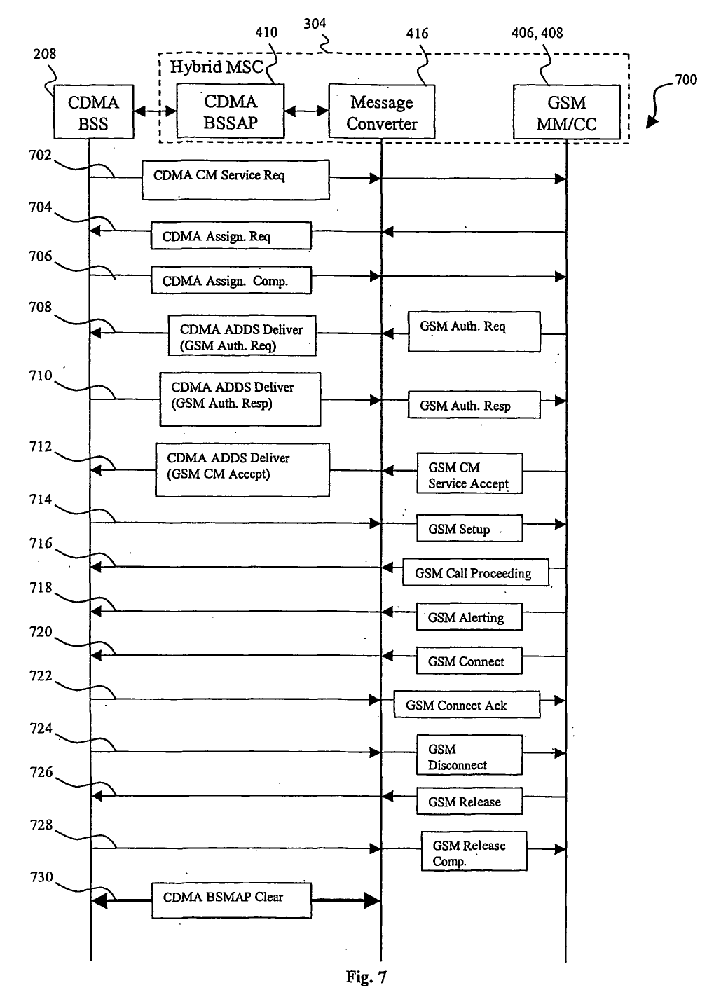

Referring now to FIG. 7, in one embodiment, a mobile originated call flow 700 is illustrated. For purposes of example, the call flow 700 is an implementation of the method 500 of FIG. 5, and is illustrated with reference to various components of the architecture 400 of FIG. 4. It is noted that although a mobile device is serviced by the call flow 700, the call flow 700 does not explicitly illustrate the mobile device. Instead, the call flow 700 interacts with the CDMA BSS 208, which is responsible for sending and receiving messages to and from the mobile device. Furthermore, although a message may be routed through various network entities, such as a PSTN, only the BSS 208 and hybrid MSC 304 (comprising the CDMA BSSAP 410, message converter 416, and GSM MM/CC agents 406, 408) are shown. It is understood that messages passing between the BSS 208 and the message converter 416 go through the BSSAP 410, although the interactions with the BSSAP 410 are not explicitly illustrated for purposes of clarity. The mobile device is a GSM/CDMA compatible device operating in a CDMA RAN (e.g., the RAN 204 of FIG. 3) and is serviced by the hybrid MSC 304 (FIG. 4).

The call is initiated when the mobile sends a CDMA CM Service Request message to the hybrid MSC 304 via the BSS 208 in step 702. The CM Service Request message contains information about the identification of the mobile device and the call type being requested. In step 704, the hybrid MSC 304 assigns a traffic channel to the mobile device by sending a CDMA Assignment Request message to the CDMA BSS 208. The BSS 208 assigns a radio traffic channel to the mobile device, and upon successful assignment, sends the message CDMA Assignment Complete to the hybrid MSC 304 in step 706. It is noted that the same messages are used in the CDMA RAN and the GSM CN. Accordingly, during these steps, the message converter 416 does very little work Assigning the traffic channel at such an early stage in the call setup procedure enables “ADDS Deliver” CDMA messages to be exchanged between the mobile device and the hybrid MSC 304. This allows the “ADDS Deliver” message to be used to efficiently transfer GSM messages over the CDMA radio interface and avoids the need to convert all of the messages to and from the different protocols.

Once the traffic channel is assigned, the call flow 700 continues with additional activities involved in a mobile originated call setup. From this point forward, the message converter 416 applies a mechanism to link the CDMA radio to the GSM MM/CC agents 406, 408 Applications and Service management layers. In the present example, this is accomplished by inserting the GSM message in the Application Data message field of the “ADDS Deliver” message. This field is based on the CDMA standard and has a flexible length, so it can hold any GSM message used between the mobile device and the GSM MM/CC agents 406, 408 during the call flow 700.

Once the “ADDS Deliver” message is received by the mobile, the mobile device extracts the GSM message and applies the GSM protocol to process the GSM data. The mobile device may then insert GSM information into an “ADDS Deliver” message and sent the CDMA message to the hybrid MSC 304 over the CDMA radio interface. This process enables the hybrid MSC 304 and the mobile device to communicate with each other using GSM messages and information in a manner that is transparent to the CDMA radio interface. This process may be used during the remaining steps of the call setup procedure as follows.

In step 708, the GSM MM/CC agents 406, 408 send an Authentication Request message to the mobile device requesting that the mobile device authenticate itself by sending GSM authentication information. The information is returned by the mobile device in an Authentication response message in step 710. In step 712, the hybrid MSC 304 sends a GSM CM Service Accept message to the mobile device indicating that the request for a call has been accepted. In step 714, the mobile device sends a Setup message to the hybrid MSC 304 that includes detailed call information on the call, such as the called party's number. In step 716, the hybrid MSC 304 sends a Call Proceeding message to the mobile device indicating to the mobile device that the call is in progress. Once the called party is reached, the hybrid MSC 304 sends an Alerting message to the mobile device in step 718 indicating that the called party has been located. When the called party answers the call, the hybrid MSC 304 sends a Connect message to the mobile device in step 720. The mobile device then replies with a Connect_Ack message in step 722 and the call is established between the mobile device and the called party.

At the end of the call, when the mobile device disconnects, a Disconnect message is sent from the mobile device to the hybrid MSC 304 in step 724. The hybrid MSC 304 then sends a Release message back to the mobile device in step 726 when a Release message is received from the called party. In step 728, the mobile device responds with a Release Complete message indicating the call has been successfully released. At this point, the CDMA radio resources are cleared, as indicated by 730.

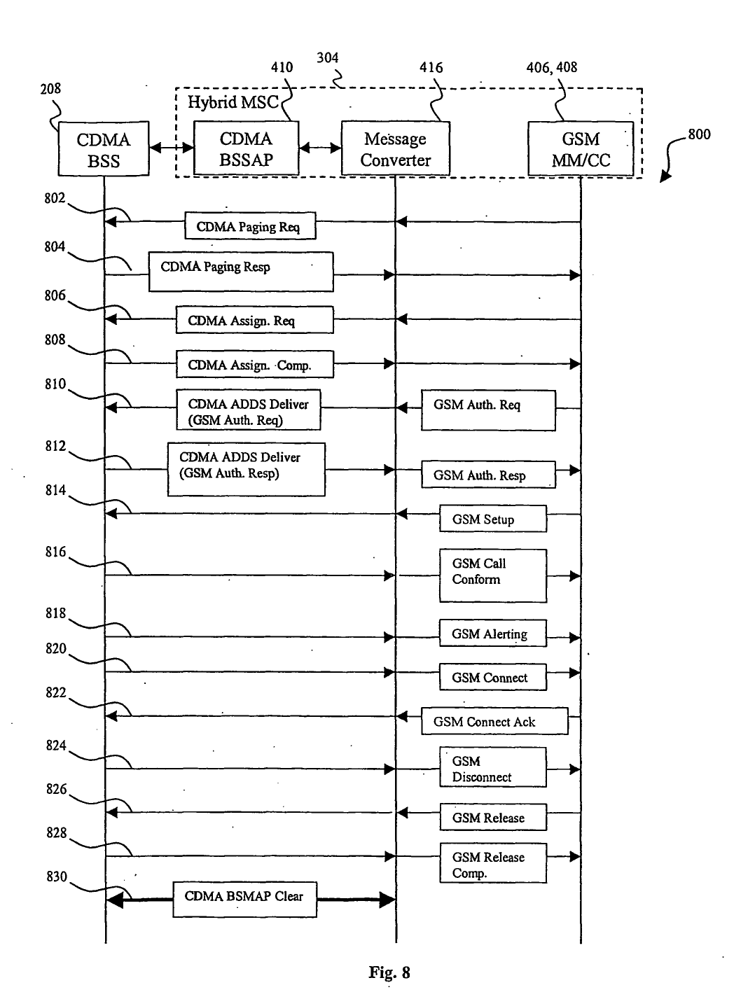

Referring now to FIG. 8, in another embodiment, a mobile terminated call flow 800 is illustrated. For purposes of example, the call flow 800 is an implementation of the method 500 of FIG. 5, and is illustrated with reference to various components of the architecture 400 of FIG. 4. It is noted that although a mobile device is serviced by the call flow 800, the call flow 800 does not explicitly illustrate the mobile device. Instead, the call flow 800 interacts with the CDMA BSS 208, which is responsible for sending and receiving messages to and from the mobile device. Furthermore, although a message may be routed through various network entities, such as a PSTN, only the BSS 208 and hybrid MSC 304 (comprising the CDMA BSSAP 410, message converter 416, and GSM MM/CC agents 406, 408) are shown. It is understood that messages passing between the BSS 208 and the message converter 416 go through the BSSAP 410, although the interactions with the BSSAP 410 are not explicitly illustrated for purposes of clarity. The mobile device is a GSM/CDMA compatible device operating in a CDMA RAN (e.g., the RAN 204 of FIG. 3) and is serviced by the hybrid MSC 304 (FIG. 4).

The call flow 800 begins with step 802 after a call has been received by the hybrid MSC 304 for the mobile device. In step 802, the hybrid MSC 304 sends a CDMA paging request message to the mobile device. The mobile device responds in step 804 by sending a Paging Response message to the hybrid MSC 304. The hybrid MSC 304 then assigns a traffic channel to the mobile device in step 806 by sending a CDMA Assignment Request message to the CDMA BSS 208. In step 808, the BSS 208 assigns a radio traffic channel to the mobile device and, upon successful assignment, sends the message CDMA assignment Complete to the hybrid MSC 304. It is noted that the same messages are used in the CDMA RAN and the GSM CN. Accordingly, during these steps, the message converter 416 does very little work. Assigning the traffic channel at such an early stage in the call setup procedure enables “ADDS Deliver” CDMA messages to be exchanged between the mobile device and the hybrid MSC 304. This allows the “ADDS Deliver” message to be used to efficiently transfer GSM messages over the CDMA radio interface.

Once the traffic channel is assigned, the GSM MM/CC agents 406, 408 continue with additional activities involved in a mobile originated call setup. From this point forward, the message converter 416 applies a mechanism to link the CDMA radio to the GSM MM/CC agents 406, 408 Applications and Service management layers. In the present example, this is accomplished by inserting the GSM message in the Application Data message field of the “ADDS Deliver” message. This field is based on the CDMA standard and has a flexible length, so it can hold any GSM message used between the mobile and the GSM MM/CC agents 406, 408 during the call flow 700.

In step 810, the GSM MM/CC agents 406, 408 send an Authentication Request message to the mobile device requesting that the mobile device authenticate itself by sending GSM authentication information. The mobile device responds in step 812 with the authentication information, which is carried in an Authentication response message. In step 814, the hybrid MSC 304 sends a Setup message to the mobile device indicating that a call is being terminated at the mobile device. The mobile device then sends a Call Conformation message to the hybrid MSC 304 in step 816, indicating that the mobile device is prepared to receive the call. In step 818, the mobile device sends an Alerting message to the hybrid MSC 304 and, in step 820, once the mobile device answers the call, the mobile device sends a Connect message to hybrid MSC 304.

In step 822, the hybrid MSC 304 replies by sending a Connect_Ack message to the mobile device, and the call is established between the mobile device and the calling party. At the end of the call, when the mobile device disconnects, a Disconnect message is sent to the hybrid MSC 304 in step 824. In step 826, the hybrid MSC 304 sends a Release message back to the mobile device after receiving a Release message from the called party. The mobile device responds with a Release Complete message in step 828 indicating the call has been successfully released. At this point, the CDMA radio resources are cleared, as indicated by 830.

In the present disclosure, it is understood that multiple messages may be used to transfer information, even though the above examples illustrate the information being encapsulated in a single message. Furthermore, the exemplary “ADDS Deliver” message used to transfer the GSM data is for illustrative purposes only, and many other types of messages may be used to encapsulate and transfer information on both the uplink and downlink. As such, the present disclosure applies to any message that may be transferred between a mobile device and a network component, such as the hybrid MSC. Furthermore, although certain message fields are described in the present disclosure for purposes of example, it is understood that any field or set of fields may be used to carry information.

Additionally, although a general switching system is used to describe the hybrid MSC, the present disclosure applies to any switching system that may include one or more network entities which have various call control systems. Such a switching system may serve one or more RANs of different technologies, as well as RANs sharing the same technology. The switching system may also link the RANs of various technologies to a CN of a predetermined wireless technology. For instance, a soft switch technology may be used to implement the hybrid MSC. The hybrid MSC may include two parts, each of which is implemented in an independent network entity. One of the two network entities may handle the control part of a call and the other network entity may handle the bearer part. Using soft switch technology to implement the hybrid MSC may provide an increased leverage of equipment investment because the network configuration may be highly scalable.

Although GSM and CDMA are used as examples in the preceding illustrations, it is understood that the disclosure applies to any two or more wireless networks that have the same CN technology but different RAN technologies. Furthermore, even though the CDMA and GSM technologies are used to describe the disclosure, the present disclosure may be applied to any wireless technology that can be used in a hybrid wireless network, and is not limited to these two particular technologies.

While the preceding description shows and describes one or more embodiments, it will be understood by those skilled in the art that various changes in form and detail may be made therein without departing from the spirit and scope of the present disclosure. For example, it is within the scope of the present disclosure that the BTS, BSS, MSC, and/or mobile device may not exist in the same fashion in other technologies or implementations, but the same functionality may be achieved using other components. Therefore, the claims should be interpreted in a broad manner, consistent with the present disclosure.

1. A method for transferring information from a network via an interface incompatible with the network to a mobile device that is compatible with both the network and the interface, the method comprising:
establishing a communication channel between the mobile device and a switch, wherein the switch is accessible to the network and is adapted to send and receive messages compatible with both the network and interface using functionality inherited directly from the network and interface;
receiving information from the network;
inserting the information into a first message compatible with the interface; and
transferring the first message to the mobile device via the interface.

2. The method of claim 1 further comprising extracting the information from the first message to recover the inserted information.

3. The message of claim 2 further comprising processing the extracted information.

4. The method of claim 1 wherein establishing the communication channel occurs prior to authenticating the mobile device in the network.

5. The method of claim 4 further comprising:
receiving a second message from the mobile device via the interface, wherein the second message is compatible with the interface; and
converting the second message received via the interface into information compatible with the network.

6. The method of claim 5 further comprising inserting information compatible with the network into the second message.

7. The method of claim 1 further comprising identifying a preselected field in the first message, wherein the information is inserted into the preselected field.

8. A method for manipulating data by a mobile station, wherein the mobile station is compatible with at least first and second incompatible telecommunications protocols, the method comprising:
receiving a first message using the first protocol;
identifying information in the first message compatible with the second protocol;
extracting the identified information from the first message; and
processing the extracted information using the second protocol.

9. The method of claim 8 further comprising:
inserting information compatible with the second protocol into a second message compatible with the first protocol; and
transmitting the second message via an air interface using the first protocol.

10. A system for enabling communications between a mobile unit and a network over an air interface, wherein the network and interface are based on first and second incompatible protocols, respectively, and wherein the mobile unit is compatible with both protocols, the system comprising:
a call controller inherited directly from the network and adapted for using the first protocol;
a mobility manager inherited directly from the network and adapted for using the first protocol and accessible to the call controller;
at least a portion of a base station inherited directly from the interface and adapted for using the second protocol; and
a message converter accessible to the call controller and the base station portion, wherein the message converter is adapted to convert information compatible with the first or second protocol into information compatible with the other protocol.

11. (canceled)

12. The system of claim 10 wherein the message converter includes a plurality of instructions, including:
an instruction for receiving a first message based on the first protocol from the network;
an instruction for inserting the first message into a second message compatible the second protocol;
an instruction for receiving a third message based on the second protocol from the interface; and
an instruction for extracting a fourth message compatible with the first protocol from the third message.

13. The system of claim 12 further comprising an instruction for converting the third message into a fifth message compatible with the first protocol if the third message does not contain the fourth message.

14. The system of claim 10 wherein the first protocol is a Global System for Mobile communications (GSM) protocol and wherein the second protocol is a code division multiple access (CDMA) protocol.

15. The system of claim 10 wherein the second protocol is a Global System for Mobile Th) communications (GSM) protocol and wherein the first protocol is a code division multiple access (CDMA) protocol.

16. A method for transferring GSM-based information between a GSM communications system and a GSM/CDMA compatible mobile device via a CDMA interface, the method comprising:
establishing a CDMA channel between the mobile device and a switch, wherein the switch is accessible to the GSM network and adapted to send and receive both GSM and CDMA messages, and wherein the switch establishes the channel using a base station system application part and radio resource manager inherited from the CDMA interface;
receiving, via a mobility management agent inherited by the switch from the GSM system,
GSM-based information from the GSM network;
inserting the information into a CDMA message; and
transferring the CDMA message to the mobile device via the CDMA interface.

17. The method of claim 16 wherein establishing the CDMA channel occurs prior to authenticating the mobile device in the GSM network.

18. The method of claim 16 further comprising:
receiving CDMA information from the mobile device; and
converting the CDMA information into GSM information for compatibility with the GSM network.

19. The method of claim 16 wherein the CDMA message is an “ADDS Deliver” message, and wherein inserting the GSM information into the CDMA message includes identifying a predetermined field in the “ADDS Deliver,” wherein the predetermined field is used to store the GSM information.

20. The method of claim 16 further comprising:
extracting the GSM information from the CDMA message; and
processing the extracted GSM information.

21. A method for transferring CDMA-based information between a CDMA communications system and a GSM/CDMA compatible mobile device via a GSM interface, the method comprising:
establishing a GSM channel between the mobile device and a switch, wherein the switch is accessible to the CDMA network and adapted to send and receive both GSM and CDMA messages, and wherein the switch establishes the channel using finctionality inherited directly from the GSM interface;
receiving, via functionality inherited by the switch from the CDMA system, CDMA-based information from the CDMA network;
inserting the information into a GSM message; and
transferring the GSM message to the mobile device via the GSM interface.

22. The method of claim 21 wherein establishing the GSM channel occurs prior to authenticating the mobile device in the GSM network.

23. The method of claim 21 further comprising:
receiving GSM information from the mobile device; and
converting the GSM information into CDMA information for compatibility with the CDMA network.

24. A hybrid mobile switching center for enabling communication between otherwise incompatible first and second telecommunication technologies, the hybrid mobile switching center comprising:
a call control agent inherited from the first technology;
a mobility management agent inherited from the first technology, wherein the mobility management agent is accessible to the call control agent;
a base station system application part and radio resource manager inherited from the second technology; and
a message converter module accessible to the mobility management agent and the base station system application part, wherein the message converter module is configured to convert messages received from the mobility management agent into the second technology and messages received from the base station system application part into the first technology, and wherein the call control agent, the mobility management agent, and the base station system application part and radio resource manager are inherited from their respective technologies without altering their configuration.
